(19) United States
(12) Patent Application Publication
(10) Pub. No.: US 2019/0026913 A1
(43) Pub. Date: Jan. 24, 2019

(54) THREE DIMENSIONAL SYMBOL FROM TWO DIMENSIONAL STILL IMAGES

(71) Applicant: Kiki Lisa Courtelis, Georgetown, KY (US)

(72) Inventor: Kiki Lisa Courtelis, Georgetown, KY (US)

(21) Appl. No.: 15/653,183

(22) Filed: Jul. 18, 2017

(51) Int. Cl. G06T 7/579; G02B 27/09; H04N 13/261; G03B 21/56

(52) U.S. Cl. CPC G06T 7/579; G03B 21/562; H04N 13/261; G02B 27/0961

(57) ABSTRACT

The present invention provides a method and device for creating and displaying a symbol comprising a two dimensional representation of a point of light that simulates depth and movement in three dimensions. The symbol is printed onto a substrate and applied as patches, magnets, stickers, cards and posters, and affixed to other surfaces such as clothing and accessories, ornaments, vehicles, building structures and other surfaces to be representative of hope and optimism. Multiple copies of symbol are applied to a three dimensional ornament to simulate a point of light in three dimensions.

### FIELD OF THE INVENTION

The present invention relates to a three dimensional symbol of a glowing point of light created from two dimensional still images of a point of light simulating depth and movement in three dimensions.

### BACKGROUND OF THE INVENTION

It is well known that symbols and logos displayed on clothing, cars, around the house and in public can send a powerful message even with relatively simple symbols. The NIKE® swoosh, Ralph Lauren's mounted polo player, yellow ribbons for military support, pink ribbons for cancer patient support, and thousands of others send a powerful and well understood message with very simple two dimensional symbols.

It is also well-known that two dimensional art can be cleverly displayed as an illusion simulating depth and movement in three dimensions by, in the most common adaptation, printing multiple copies of a two dimensional work of art viewable through multiple “lenses” so that a viewer of the artwork with a slight change in position will have a differing perception as a result of the view changing through the “lenses”.

One example method of presenting two dimensional artwork in three dimensions is “lenticular” printing, wherein a grid of lenses having, for example, spherical or cylindrical convex surfaces is layered on top of a work of art or, preferably, multiple slightly offset copies of the work, such that a viewer's perception of the work(s) of art will change as the angle through which it is viewed changes due to the convex lens. The inventors herein have discovered and applied this technology in a particularly effective way to the presentation of rays of sunshine, as shown in FIGS. 1 and 2. By presenting a ray of sunshine emanating from the sun as multiple copies of a two dimensional sun with rays emanating therefrom, and then layering an array of lenses thereon, an illusion of a glowing sun with the illusion of depth and movement is created as the relative position of the viewer to the artwork changes. The glowing rays of sunshine are a particularly effective adaptation of lenticular printing, and the inventors have adapted it as an expression of hope and have applied it to multiple substrates in an effort to make it usable, conspicuous and pervasive, and affixable to a vast array of surfaces and things.

The inventor has applied this artistic feature simulating a ray of sunshine in three dimensions to create a symbol and logo, a two dimensional representation that can be affixed to other articles, as a symbol of hope and optimism. In this way, the inventor has adopted the particularly effective three-dimensional illusion of a glowing point of light as a “ray of sunshine”, a symbol of hope and optimism.

The inventors have also applied the novel three-dimensional ray of sunlight illusion graphic to multiple faces of three dimensional objects to provide an inspirational ornament symbolizing hope with the illusion of a glowing point of light therein.

### Objects of the Invention

It is an object of the present invention to provide a three dimensional illusion of a sun with projecting rays of light emanating from it.

It is another object of the present invention to provide a two dimensional work of art creating the illusion of three dimensions having means for being affixed to articles of clothing and apparel.

It is yet another object of the present invention to provide a two dimensional work of art creating the illusion of three dimensions having means for being affixed to generally flat non magnetic surfaces.

It is another object of the present invention to provide a two dimensional work of art creating the illusion of three dimensions having means for being affixed to ferromagnetic surfaces.

It is yet another object of the present invention to provide an ornament having multiple faces, each having a two dimensional representation of a glowing sun comprising an illusion in three dimensions such that the ornament appears to have a glowing point of light therein.

It is yet another object of the present invention to provide a two dimensional symbol of hope creating the illusion of movement and depth in three dimensions.

It is yet another object of the present invention to provide a two dimensional symbol of hope creating a three dimensional illusion of depth and movement that is affixed to a variety of substrates, the substrates being affixable to articles of clothing and apparel, magnetic flat surfaces and non magnetic surfaces.

It is yet another object of the present invention to provide a recognizable logo affixed to a wide variety of articles comprising a two dimensional symbol creating the illusion of depth and movement.

It is yet another object to create a logo comprising an effective two dimensional representation of a glowing point of light emulating a three dimensional representation.

### SUMMARY OF THE INVENTION

The present invention comprises a flat two-dimensional representation of a point of light simulating depth and movement in three dimensions. For purposes of establishing a logo the point of light is characterized as a ray of sunshine. Multiple two dimensional images of a point of light with rays emanating outwardly are printed on a top side of a substrate, and multiple lenses are positioned over the multiple two dimensional images so that slight relative movement between a viewer and the flat two dimensional representation alters the perception of the viewer and creates the appearance of depth and motion of the flat representation. The lenses are transparent convex surfaces that alter the reflection and refraction of light on the two dimensional representations of a point of light to create the illusion of glowing in three dimensions perceived by a viewer.

In the most preferred embodiment of the present invention, the two dimensional images and lenses are mounted on the top side of a substrate. In this way the two dimensional images and lenses may be affixed to a wide variety of articles as a logo and identifying symbol. On the bottom side of the substrate there are various methods for affixing the substrate to an article such as chemical adhesive, a magnetic surface, or a layer of fabric that may be secured using Velcro or stitching.

In another embodiment of the present invention, multiple copies of a two dimensional representation of a point of light creating the illusion of a three dimensional glowing point of light are affixed to a three dimensional object to create the illusion of a three dimensional point of light within the object. This embodiment is particularly effective when multiple copies of the two dimensional representation are applied to, for example, the multiple faces of a pyramid or spheroid, such that the pyramid appears to have a glowing point of light in the center. An ornament comprising any three dimensional shapes with representations of a glowing point of light therein creating the illusion is contemplated within the bounds of the present invention.

A method for creating a symbol representing hope is also contemplated within the scope of the present invention consistent with the well understood optimism of a “little ray of sunshine”. A two dimensional representation of a point of light having rays emanating therefrom is provided and viewed through multiple lenses such that a viewer perceives the multiple two dimensional representation as an illusion simulating movement and depth as a result of multiple convex lenses. The two dimensional representation creating a three-dimensional illusion of a glowing point of light is disseminated and affixed to articles utilizing affixation means to do so. For purposes of logo identification, the point of light is characterized as a ray of sunshine, and emphasized as a universal symbol of hope. A public identity and business associated with the illusion is perceived positively as a result of the metaphorical ray of sunshine.

### BRIEF DESCRIPTION OF THE DRAWINGS

FIG. 1 is a perspective exploded view of the present invention reflecting the multiple lenses layer on top of the multiple two dimensional representations.

FIG. 2 is a schematic representation of the two dimensional representation of the present invention viewed through multiple lenses.

FIG. 3 is a two dimensional representation of the present invention with multiple separate images of a glowing point of light with emanating rays printed on a substrate.

FIG. 4 is a side view of the present invention illustrating the layer of lenses adjacent the two dimensional representation of the substrate and bottom layer for affixation to a surface.

FIG. 5 is a schematic illustration of the changing lines of sight between two positions resulting from the lenses and how it changes the perception of the viewer.

FIG. 6A is an illustration of the present invention affixed to a baseball cap.

FIG. 6B is an illustration of the present invention affixed to a car.

FIG. 6C is an illustration of the present invention affixed to a sweatshirt.

FIG. 6D is an illustration of the present invention affixed to a backpack.

FIG. 6E is an illustration of the present invention affixed to a refrigerator.

FIG. 7A is a perspective illustration of multiple copies of the two dimensional representation affixed to multiple faces of a three dimensional pyramid.

FIG. 7B is a perspective illustration of multiple copies of the two dimensional representation affixed to multiple faces of a three dimensional spheroid.

### DETAILED DESCRIPTION OF THE INVENTION

A two dimensional symbol 2 is created by a flat representation 10 of multiple still images 12 to simulate a three dimensional point of light 6 with rays 8 emanating therefrom. The perception of the multiple still images 12 changes as they are viewed through a layer 14 of lenses 17 that provide a non-uniform layer of a transparent material, for example and without limitation, PVC, acrylic, PET or any other similarly formable and transparent material. The non-uniform format of the layer 14 resulting from, for example, the spherical or cylindrical shape the lenses 17, changes the perception of the images 12 observed by a viewer 15 (FIG. 5).

By changing the relative position only slightly between the viewer 15 and the flat representation 10 of the present invention, even just turning or moving the symbol 10 slightly, changes the angle of incidence of light on the logo 2 and creates the appearance of simulated depth and movement. This illusion of depth and radiance of light is made possible by the construction of the symbol 2 and by the nature of light propagation through the different materials of the lenses 17.

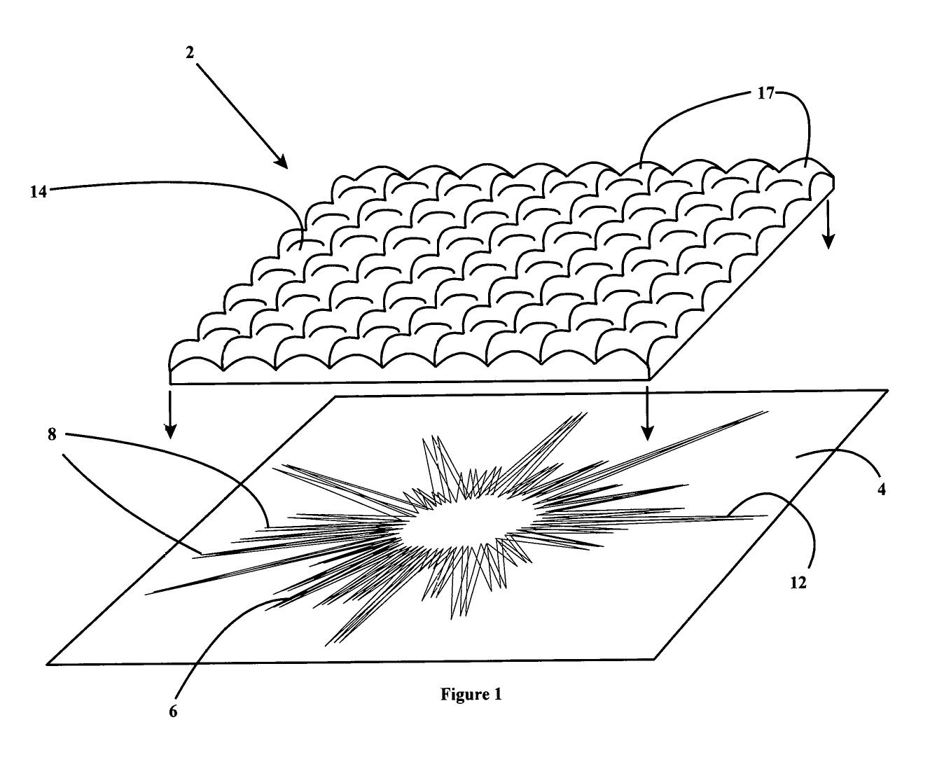

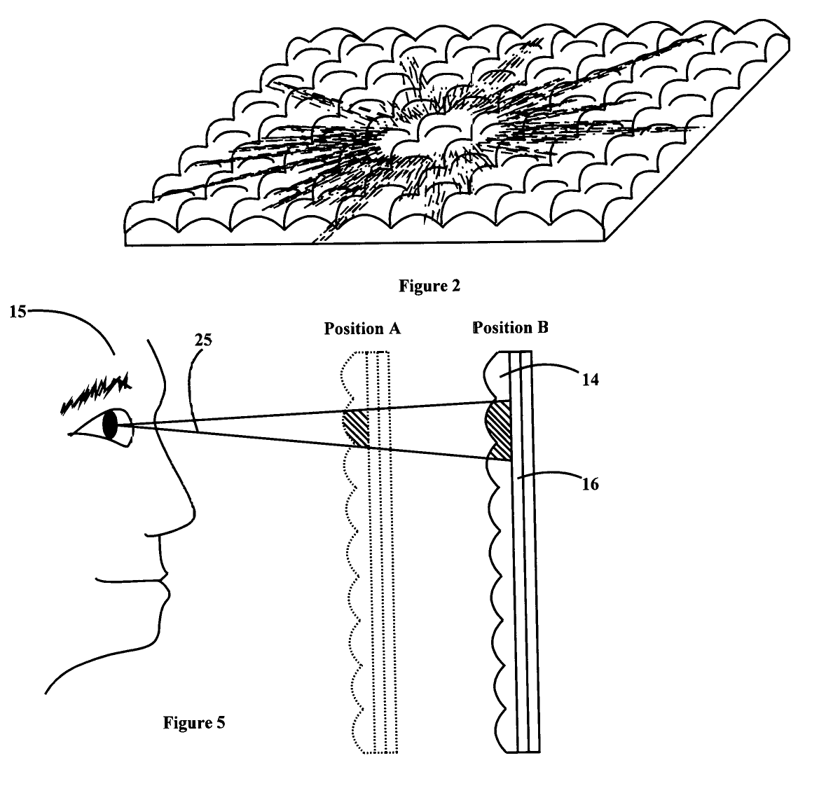

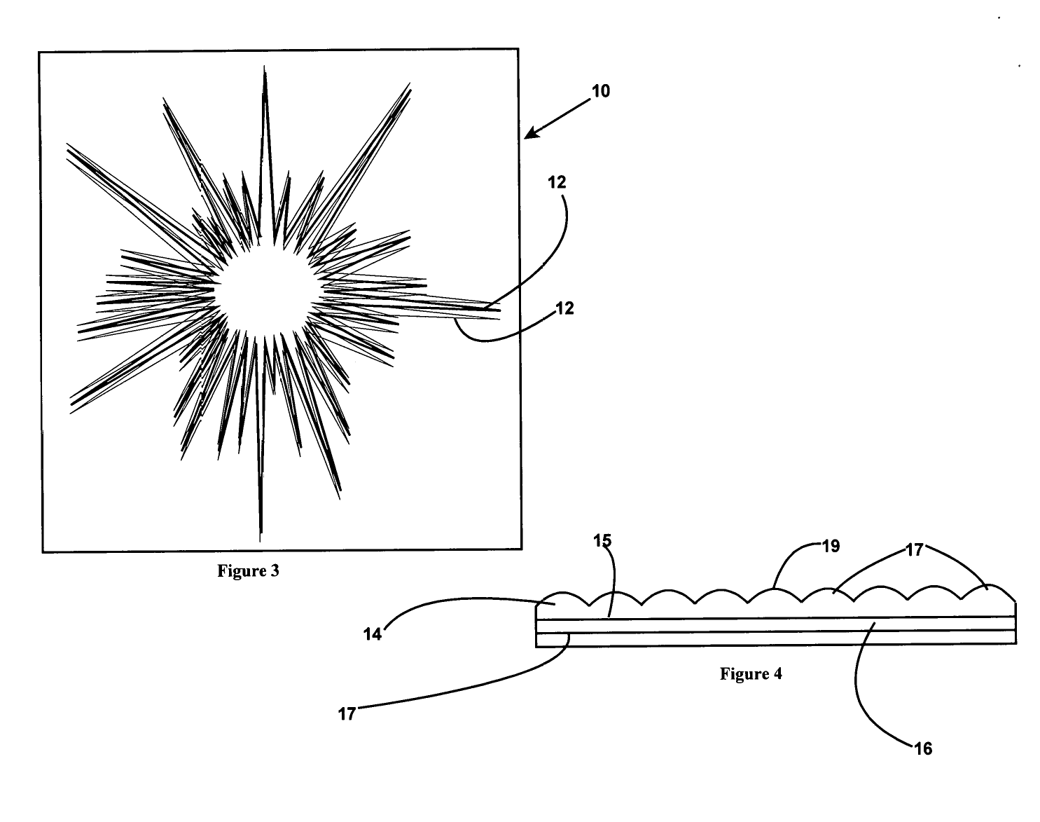

As shown in FIG. 1, the symbol 2 comprises multiple two dimensional still images 12 of a point of light 6 having rays 8 emanating from it. A layer 14 of lenses 17, also known as lenticules, is provided adjacent to the still images 12 so that the still images 12 will be viewed through the layer 14 of lenses 17, the lenses 17 altering reflection and refraction of light passing through them. In the most preferred embodiment of the invention, the still images 12 are printed onto a top layer 15 of a substrate 16 and then the layer 14 is affixed to the substrate 16 by means that do not interfere with the perception of the still images through the lenses 17. As an alternative, the still images 12 may be printed directly onto the underside of the layer 14 to eliminate the necessity for the substrate 16.

As shown in FIG. 5, a viewer 15 has a line of sight 25 and perceives the still images printed on substrate 16 by looking through the layer 14 of nonuniform lenses 17. Noting the nature of propagation of light as it passes through the transparent material making up layer 14, it is obvious that, with only a slight change in position from position A to position B, the perception of the viewer 15 changes. The nonuniformity of the lenses layer 14 results in a distorted view of the images 12 and it is this alteration in perception resulting from the non-uniform layer 14 that causes the still images 12 to appear to be glowing, creating illusion of three-dimensional movement and depth.

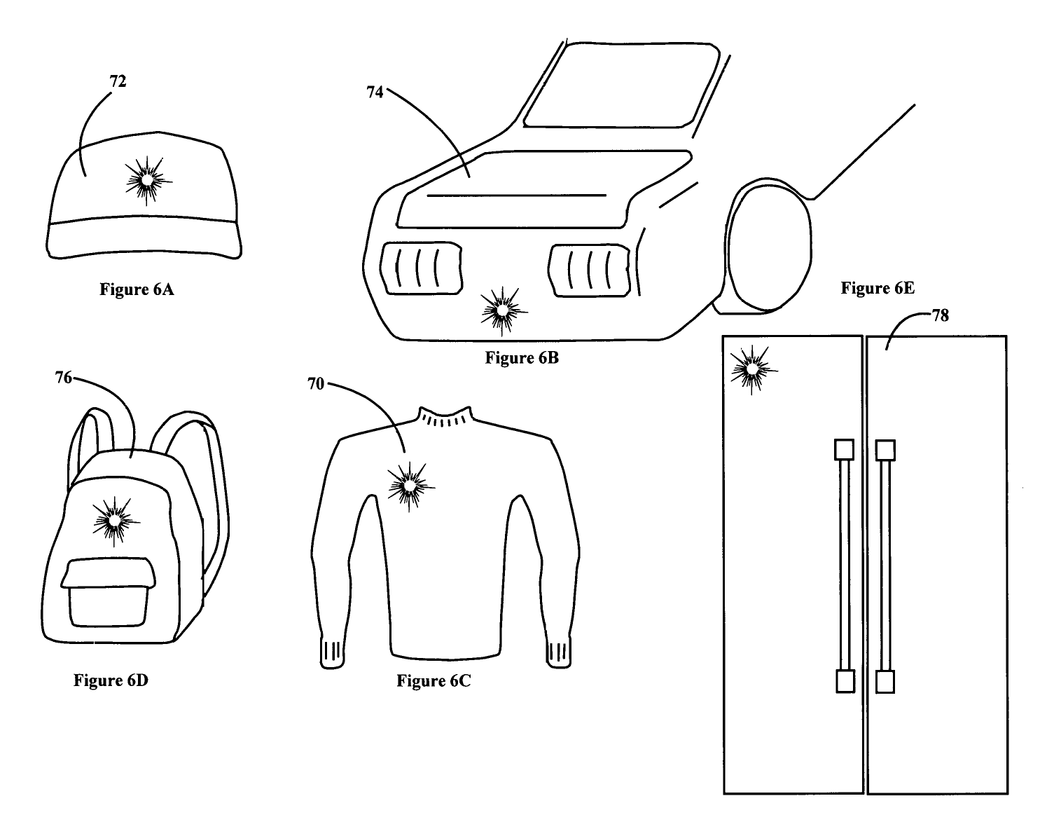

The inventor has particularly adapted the principles of lenticular printing to create a symbol that may be used as a logo comprising an effective illusion of a glowing point of light 6, and have further advanced their invention by providing means for affixing 18 the symbol 2 to a variety of surfaces and things. Specifically, a means for affixing layer 18 is provided on the bottom side 17 of the substrate 16 on which the still images 12 are printed. The layer comprising the means for affixing 18 comprises a variety of devices to secure the symbol 2 to surfaces. For example, a layer of adhesive is applied to secure the symbol 2 to nonmetallic, flat surfaces. In the most preferred embodiment, the adhesive is releasable and reusable. In addition, a layer comprising a magnet is provided as a means for affixing 18 the symbol 2 can to ferromagnetic services, such as metallic panels of an automobile 74 or a refrigerator 78. Further, the means for affixing 18 may comprise the layer of fabric to which the substrate 16 and layer 14 are secured that is secured to articles of clothing or accessories, such as a baseball cap 72 (FIG. 6A), a sweatshirt 70 (FIG. 6C) or a backpack 76 (FIG. 6D). The layer of fabric may be secured two other fabric, such as a baseball cap, sweatshirt or backpack by means of stitching, Velcro strips, a sip or four button connections between the layers of fabric.

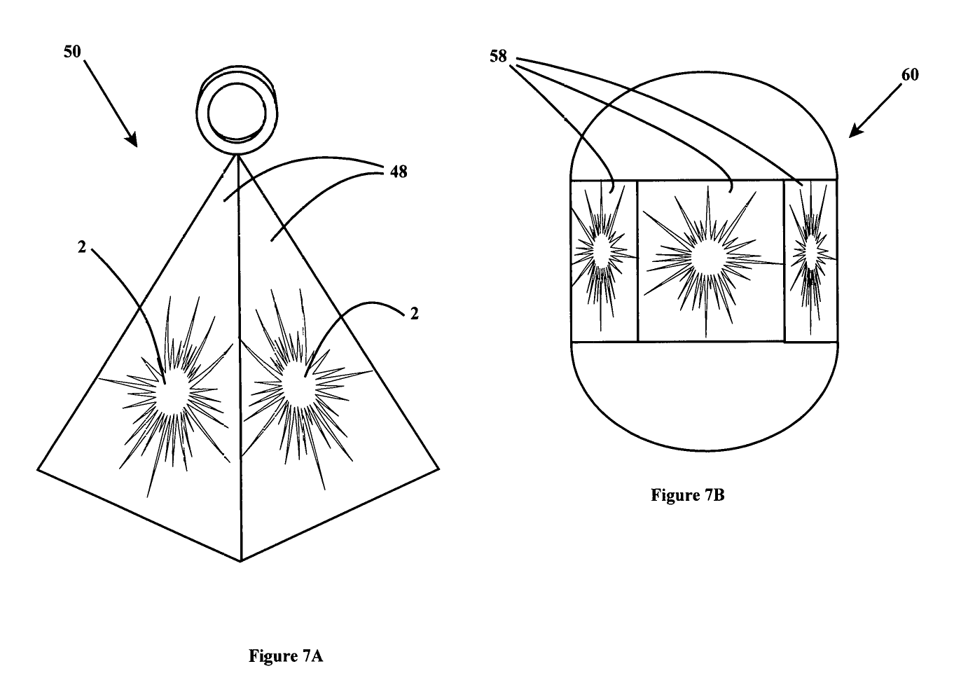

The inventor has further provided multiple copies of the symbol 2, a two dimensional representation creating a three dimensional illusion, that is affixed to multiple faces of a three-dimensional article, such as an ornament, to create a unique ornament giving the illusion of a glowing point of light within the article. Specifically, as shown in FIG. 7A, the inventors have applied multiple copies of the symbol 2 to the flat faces of a pyramid 50, creating the illusion of a glowing point of light within the pyramid 50. Similarly, multiple copies of the symbol 2 have been attached to the flattened surfaces 58 of a spheroid 60, as shown in FIG. 7B to create another version of an ornament having the illusion of a point of light within the ornament.

The inventor has thus provided a unique symbol 2, comprising a three-dimensional illusion of a glowing point of light, and have provided means for fixing the symbol 2 to a vast array of surfaces and things.
Flat representation of a ray of sunshine 10
Multiple two dimensional still images 12
Multiple lenses 14
Top side of substrate 15
Substrate 16
Bottom side of substrate 17
Means for affixing 18
Affixed to variety of articles:
   Clothing 70
   Accessories 72
   Vehicles 74
   Luggage 76
   Appliances 78
Means for affixing comprises:
   Adhesive
   Magnet
   Stitching (fabric)
   Velcro
Applied to 3D pyramid ornament 50

Flat faces of pyramid 48
Applied to 3D spheroid ornament 60

Flat faces of spheroid 58

The inventor has adopted the symbol 2, a two dimensional item creating the illusion of a glowing point of light in three dimensions, to provide a distinctive symbol to be used in the same way two dimensional logos are used to identify products, services and other meanings. The use of the lenticular process provides for an especially effective illusion of a glowing point of light, And the inventor has chosen to adopt such as a symbol of hope. In so far as a ray of sunshine is generally associated with positive and uplifting messages of hope and optimism, the inventor has adopted the symbol, a three-dimensional illusion of a point of light, as a logo. The inventors symbol 2 is designed and intended to represent hope and optimism and to carry a positive message.

The inventor has also created a method for establishing a nexus between a distinctive symbol and a business by utilizing a three-dimensional illusion comprising a symbol 2, in the most preferred embodiment the symbol 2 being the particularly effective representation of a point of light as set forth herein. The inventor has disseminated the symbol comprising a three-dimensional illusion to be affixed to other articles and characterized the point of light illusion as a “ray of sunshine” to reinforce the metaphoric meaning of hope and optimism associated with a ray of sunshine. The inventor has utilized the symbol, a three-dimensional illusion of a glowing point of light, to establish and reinforce a public identity and business associated with hope and optimism.

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention and is made merely for the purpose of providing a full and enabling disclosure of the present protection. The detailed disclosure herein of one or more embodiments is not intended, nor is to be constructed, to limit the scope of patent protection afforded the present invention, which scope is to be defined by the claims and the equivalents thereof.

It is not intended that the scope of the patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods are not limited to being carried out in any particular sequence or order, absent an indication otherwise. Indeed, the steps in such process or methods generally may be carried out in various different sequences and orders while still falling within the scope of the present invention. Accordingly, it is intended that the scope of the patent protection afforded the present invention is to be defined by the appended claims rather than the description set forth herein.

Additionally, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to a “picnic basket having a single apple” describes “a picnic basket having only one apple.”

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese and crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto

I claim:

1. A symbol comprising a flat representation of a point of light with rays emanating outwardly simulating depth and movement in three dimensions comprising:
Multiple two dimensional images of a point of light with rays emanating outwardly printed on a top side of a substrate;
Multiple lenses through which said two dimensional images are visible to a viewer;
Wherein slight relative movement between said viewer and said symbol alters the perception to said viewer to create the appearance of depth and movement in three dimensions.

2. The symbol as set forth in claim 1 wherein said multiple lenses further comprise means for altering refraction and reflection of light passing through said lenses to create the illusion of glowing perceived by the viewer.

3. The symbol as set forth in claim 2 wherein said two dimensional images and said multiple lenses are mounted on a top layer of a substrate.

4. The symbol as set forth in claim 3 wherein said substrate has an underside opposite said top layer and means for affixing said symbol to an article.

5. The symbol as set forth in claim 4 wherein said means for affixing comprises chemical adhesive.

6. The symbol as set forth in claim 5 wherein said chemical adhesive comprises adhesive that adheres to an article and is removable and reusable upon application of force.

7. The symbol as set forth in claim 4 wherein said means for affixing comprises a magnet for affixation to a ferromagnetic article.

8. The symbol as set forth in claim 4 wherein said means for affixing comprises a layer of fabric secured to said opposed side of said substrate wherein said symbol is affixed to articles of clothing and accessories.

9. The symbol as set forth in claim 4 wherein multiple copies of said symbol are affixed to a three dimensional object to create the illusion of a three dimensional point of light.

10. A method for creating a symbol of hope comprising a glowing point of light comprising the steps of:
Providing multiple two dimensional representations of a point of light having rays emanating therefrom;
Providing multiple lenses through which a viewer perceives said multiple two dimensional representations whereby slight relative movement between the viewer and said symbol of hope creates the illusion of motion and depth;
Providing a substrate having means for affixing said symbol of hope to multiple article surfaces.

11. A method for creating a nexus between a distinctive symbol and a business comprising the steps of: providing a three-dimensional illusion of a point of light with a two dimensional representation;
Disseminating said three-dimensional illusion in multiple forms for affixation two other articles;
Characterizing said illusion of a point of light as a ray of sunshine;
Emphasizing a ray of sunshine as a metaphor for Hope;
Establishing a public identity and business associated with hope and optimism.
